(19) United States
(12) Patent Application Publication
(10) Pub. No.: US 2015/0251886 A1
(43) Pub. Date: Sep. 10, 2015

(54) FORKLIFT PIPE CRADLE

(71) Applicant: Rockwater Energy Solutions, Houston, TX (US)

(72) Inventors: Cody Sutterfield, Fulton, TX (US); Ben Glenn, Rockport, TX (US)

(73) Assignee: Rockwater Energy Solutions, Houston, TX (US)

(21) Appl. No.: 14/199,384

(22) Filed: Mar. 6, 2014

(51) Int. Cl. B66F 9/18

(52) U.S. Cl. CPC B66F 9/18

(57) ABSTRACT

A pipe cradle for gripping a pipe using a forklift is disclosed. The pipe cradle includes a first cradle attachment, wherein the first cradle attachment including a first concave face, and a second cradle attachment, the second cradle attachment including a second concave face. The first and second concave faces are positioned to face each other when the first and second cradle attachments are positioned on a corresponding first and second fork of the forklift.

### CROSS-REFERENCE TO RELATED APPLICATIONS

This application is a non-provisional application which claims priority from U.S. provisional application No. 61/744,995, filed Mar. 8, 2013.

### TECHNICAL FIELD/FIELD OF THE DISCLOSURE

The present disclosure relates generally to manipulating pipes and other tubular or cylindrical objects.

### BACKGROUND OF THE DISCLOSURE

Pipes, especially those used in oilfield applications, tend to be too heavy and unwieldy to move manually. As such, pipes are often manipulated using heavy-weight equipment. In some instances, a forklift may be used to manipulate the pipes. Typically, the forklift has two forks that may be slid underneath the pipe and subsequently used to lift and transport the pipe from one location to another. In some forklifts, the lateral distance between the two forks may be hydraulically adjusted closer or farther apart as needed based on the size of the object being transported. Typically, the two forks are smooth, allowing the forks to be slid under, for example, flat, rectangular objects. Various techniques have been attempted to secure pipes to the forks, including the use of chains, ropes, and the like.

### SUMMARY

In an embodiment a pipe cradle for gripping a pipe using a forklift is disclosed. The pipe cradle includes a first cradle attachment, wherein the first cradle attachment including a first concave face, and a second cradle attachment, the second cradle attachment including a second concave face. The first and second concave faces are positioned to face each other when the first and second cradle attachments are positioned on a corresponding first and second fork of the forklift.

In another embodiment, a method is disclosed. The method includes positioning a first cradle attachment on a first fork of a forklift, the first cradle attachment including a first concave face. The method further includes positioning a second cradle attachment on a second fork of the forklift, wherein the second cradle attachment including a second concave face. The second concave face is generally parallel to and facing the first concave face. The method also includes positioning, by moving the forklift, the first and second cradle attachments on either side of a pipe, the pipe generally aligned between and parallel to the first and second concave faces, moving the first and second forks towards each other, and contacting the pipe with the first and second concave faces. In addition, the method includes lifting, by raising the first and second forks, the pipe and moving the pipe.

In still another embodiment, a method for manufacturing a cradle attachment for gripping a pipe using a forklift is disclosed. The method includes providing a pipe section having a radius generally the same as the pipe to be gripped, cutting the pipe section at least once laterally to form two annular sectional segments, and coupling each annular sectional segment to a fork of the forklift such that the convex inner surface of each annular sectional segments faces the inner surface of the other annular sectional segment.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a forklift having installed thereon a forklift pipe cradle consistent with embodiments of the present disclosure.

FIG. 2 depicts a top plan view of the forklift pipe cradle of FIG. 1.

FIG. 3A depicts a front elevation view of the forklift pipe cradle of FIG. 1.

FIG. 3B depicts a perspective view of a single forklift pipe cradle of FIG. 1.

FIG. 4 depicts a forklift pipe cradle consistent with embodiments of the present disclosure.

FIG. 5 depicts a forklift pipe cradle consistent with embodiments of the present disclosure.

FIG. 6 depicts a forklift pipe cradle consistent with embodiments of the present disclosure.

FIG. 7 depicts a forklift pipe cradle consistent with embodiments of the present disclosure gripping a pipe.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

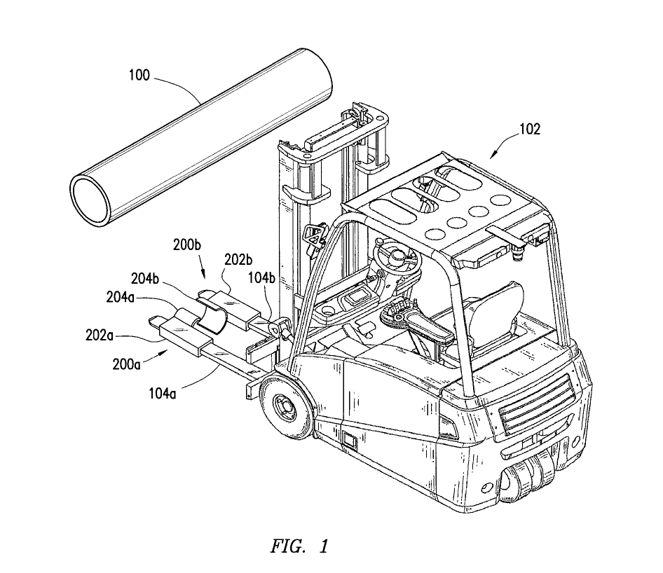

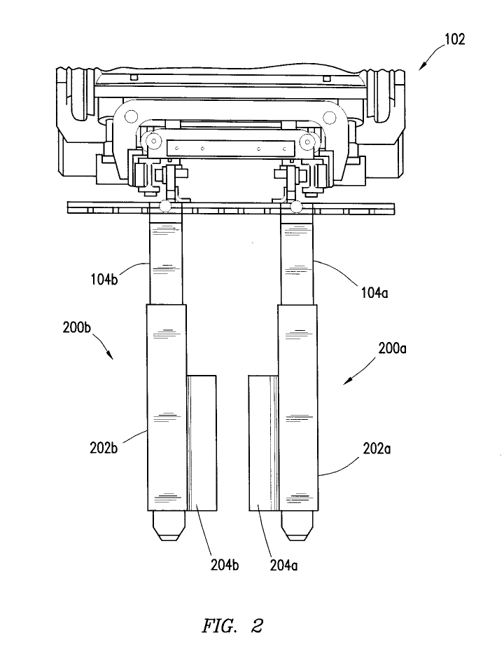

FIG. 1 depicts forklift 102 positioned near pipe 100. Pipe 100 may be constructed of a variety of materials of construction. One non-limiting material of construction is plastic piping, such as PVC. Forklift 102 includes two forks 104a, b, extending therefrom positioned, as understood in the art, to lift object. Each fork 104a, b, is a generally rectangular extension which is positionable by the operator of forklift 102 in both the vertical direction, and horizontally moving closer together or farther apart.

Cradle attachments 200a, 200b are coupled to forks 104a, 104b, respectively. Each cradle attachment 200a, 200b may include sleeve portion 202a, 202b, and cradle portion 204a, 204b. Cradle portions 204a, 204b have a convex inner surface positioned so that when cradle attachments 200a, 200b are affixed to forks 104a, 104b of forklift 102, the inner surfaces of cradle portions 204a, 204b face each other. Sleeve portions 202a, 202b may be positioned to fit around forks 104a, 104b to secure cradle attachments 200a, 200b to forks 104a, 104b. In some embodiments, sleeve portions 202a, 202b may be longer than cradle portions 204a, 204b to, for example, provide a larger contact area between cradle attachments 200a, 200b and forks 104a, 104b. One having ordinary skill in the art with the benefit of this disclosure will understand that sleeve portions 202a, 202b may be longer, shorter, or the same length as cradle portions 204a, 204b without deviating from the scope of this disclosure. Additionally, cradle portions 204a, 204b may be positioned at any point along cradle attachments 200a, 200b without deviating from the scope of this disclosure.

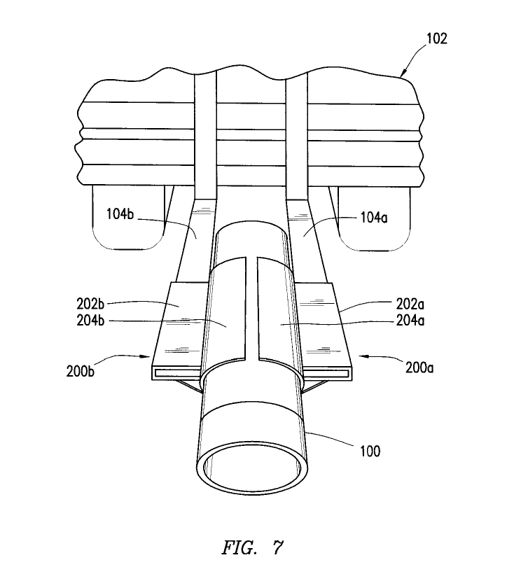

In operation, when forks 104a, 104b are moved closer together, cradle portions 204a, 204b may thus grip about the outer surface of pipe 100 when pipe 100 is positioned therebetween as depicted in FIG. 7. Once pipe 100 is gripped by cradle attachments 200a, 200b, forklift 102 may proceed to lift, move, or otherwise relocate pipe 100. Because of the convex shape of cradle portions 204a, 204b, cradle attachments 200a, 200b, cradle portions 204a, 204b may fit flush against pipe 100, providing a secure, clamp-like grip.

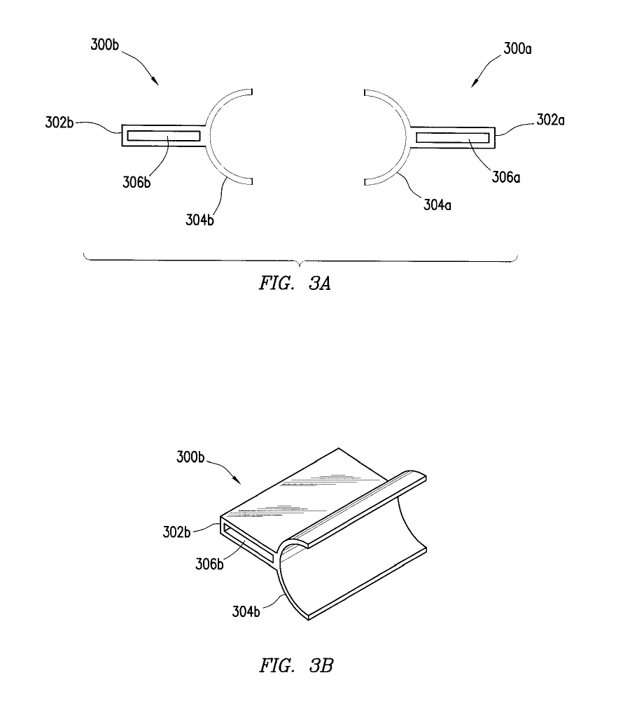

FIG. 3A depicts a front view of a set of exemplary cradle attachments 300a, 300b in accordance with embodiments of the present disclosure. As previously described, each cradle attachment 300a, 300b may include sleeve portion 302a, 302b and cradle portion 304a, 304b affixed thereto. Each sleeve portion 302a, 302b may have a space or hollow area 306a, 306b extending lengthwise through the middle thereof and having sufficient dimension to receive therein fork 104a, 104b. In some embodiments, each sleeve portion 302a, 302b may also have one or more securing mechanisms for securing it to forklift fork 104a, 104b either permanently or temporarily. Such securing mechanisms are well known to those having ordinary skill in the art and are therefore not described in detail here.

As for the cradle portions 304a, 304b, in some embodiments, each cradle portion 304a, 304b may have a substantially semicircular profile for making contour-fitting contact with the surface of pipe 100. In some embodiments, a full semicircular profile may be used on each cradle portion 304a, 304b. One having ordinary skill in the art with the benefit of this disclosure will understand that a full semicircular profile is not required. For example, in some embodiments of the present disclosure, the profile of cradle portions 304a, 304b may be an arc of, for example and without limitation, approximately 150 degrees, approximately 120 degrees, or other angles without deviating from the scope of this disclosure. In some embodiments, the radius of each cradle portion 304a, 304b may be substantially the same as the radius of pipe 100 being manipulated. In some embodiments, cradle portions 304a, 304b may be formed from a second piece of pipe matching pipe 100. The second piece of pipe, which may be a one-foot piece, two-foot piece, three-foot piece, and so on, may then be cut into halves, or thirds, or some other fraction, and each half or third (or other fraction) of the piece of pipe may be affixed to sleeve portion 302a, 302b to form cradle portions 304a, 304b.

Affixing the cradle portions 304a, 304b to the sleeve portions 302a, 302b may be accomplished using any technique known to those having ordinary skill in the art. For example, each cradle portion 304a, 304b may be welded or brazed to a respective sleeve portion 302a, 302b in some embodiments. In other embodiments, cradle portions 304a, 304b may bolted, riveted, or screwed to the respective sleeve portion 302a, 302b. The choice of affixing method may, in some embodiments, be determined at least in part by the type of material (e.g., steel, cast iron, etc.) used for the cradle portions 304a, 304b and sleeve portions 302a, 302b, and whether they are the same material. In some embodiments, cradle portions 304a, 304b and sleeve portions 302a, 302b may be manufactured (e.g., extruded, etc.) as a single unitary component.

FIG. 3B depicts a perspective view of one of the cradle portions 304a, 304b from FIG. 3A. As can be seen in this example, the cradle portion 304b and the sleeve portion 302b are substantially equal in length.

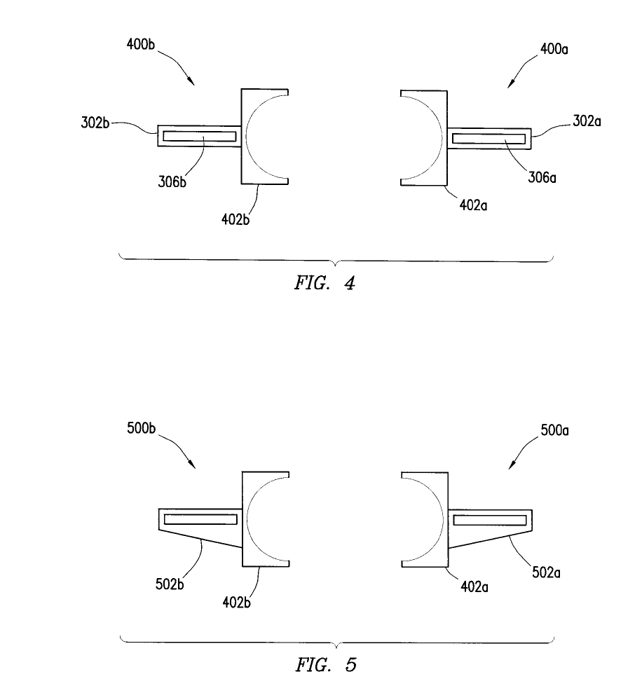

In some embodiments, rather than a semicircular profile, the profiles of the cradle portions may resemble that shown in FIG. 4. Here, cradle attachments 400a, 400b may include cradle portions 402a, 402b in which the sides opposite the pipe-contacting sides are flat rather than curved. The flat sides may provide more surface area to support affixing or otherwise attaching the cradle portions 402a, 402b to sleeve portions 304a, 304b.

In some embodiments, such as that depicted in FIG. 5, additional support may also be provided to couple cradle portions 402a, 402b to sleeve portions 502a, 502b. There, cradle attachments 500a, 500b have sleeve portions 502a, 502b in which the sides that connect to the cradle portions 402a, 402b are extended in one or more directions, thus, for example, increasing the available contact surface for the cradle portions 402a, 402b.

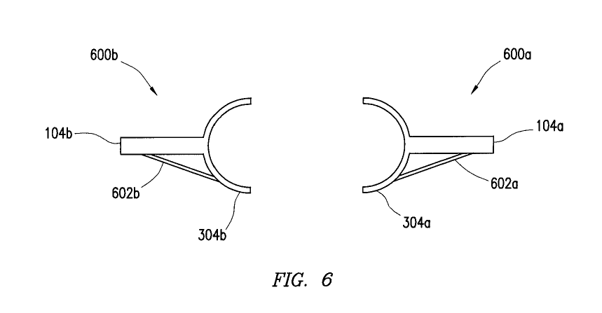

In some embodiments, such as that depicted in FIG. 6, cradle portions 304a, 304b may be affixed to, mounted on, or otherwise coupled directly to forks 104a, 104b themselves. Cradle attachments 600a, 600b may include cradle portions 304a, 304b that may be welded, brazed, or otherwise coupled directly to the forklift forks 104a, 104b. In some embodiments, because the forklift forks tend to have a somewhat reduced contact surface area for supporting the cradle portions 304a, 304b, an additional support structure, such as a strut or brace 602a, 602b, may be coupled (e.g., welded, brazed, etc.) between forks 104a, 104b and cradle portions 304a, 304b as depicted.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A pipe cradle for gripping a pipe using a forklift comprising:
a first cradle attachment, the first cradle attachment including a first concave face;
a second cradle attachment, the second cradle attachment including a second concave face,
the first and second concave faces positioned to face each other when the first and second cradle attachments are positioned on a corresponding first and second fork of the forklift.

2. The pipe cradle of claim 1, wherein the first cradle attachment further comprises a first sleeve portion, the first sleeve portion coupled between the first concave face of the first cradle attachment and the first fork of the forklift.

3. The pipe cradle of claim 2, wherein the first fork of the forklift is generally rectangular in cross-section, and the first sleeve portion is generally tubular and configured to fit about the first fork.

4. The pipe cradle of claim 2, wherein the first sleeve portion is coupled to the first fork by a locking mechanism.

5. The pipe cradle of claim 1, wherein the first cradle attachment further comprises a first cradle portion, the first cradle portion including the first concave face and coupled to the first fork.

6. The pipe cradle of claim 5, wherein the first cradle portion is formed from a section of pipe.

7. The pipe cradle of claim 5, further comprising at least one support structure extending between the first fork and the first cradle portion.

8. The pipe cradle of claim 1, wherein the first cradle attachment further comprises a first sleeve portion, the first sleeve portion coupled to the first fork, and a first cradle portion, the first cradle portion including the first concave face and coupled directly to the first sleeve portion.

9. The pipe cradle of claim 8, wherein the first sleeve section includes at least one rib extending therefrom, the rib extending to the first cradle portion and positioned to increase the strength of the joint between the first sleeve section and the first cradle portion.

10. The pipe cradle of claim 8, wherein the first sleeve portion is coupled to the first cradle portion by at least one of welding, brazing, bolting, riveting, or screwing.

11. The pipe cradle of claim 8, wherein the first cradle attachment is formed by extrusion.

12. A method comprising:
positioning a first cradle attachment on a first fork of a forklift, the first cradle attachment including a first concave face;
positioning a second cradle attachment, on a second fork of the forklift, the second cradle attachment including a second concave face, the second concave face generally parallel to and facing the first concave face;
positioning, by moving the forklift, the first and second cradle attachments on either side of a pipe, the pipe generally aligned between and parallel to the first and second concave faces;
moving the first and second forks towards each other;
contacting the pipe with the first and second concave faces;
lifting, by raising the first and second forks, the pipe;
moving the pipe.

13. The method of claim 12, further comprising:
lowering the first and second forks;
positioning the pipe at a desired location;
moving the first and second forks away from each other.

14. The method of claim 12, wherein the first cradle attachment further comprises a first sleeve portion, the first sleeve portion coupled between the first concave face of the first cradle attachment and the first fork of the forklift.

15. The method of claim 14, wherein positioning the first cradle attachment on the first fork further comprises sliding the first sleeve portion onto the first fork.

16. The method of claim 15, further comprising locking the first sleeve portion to the first fork.

17. The method of claim 12, wherein the first cradle attachment further comprises a first cradle portion, the first cradle portion including the first concave face and coupled to the first fork.

18. The method of claim 17, wherein the first cradle portion is formed by:
cutting a pipe section having generally the same radius as the pipe;
cutting the pipe section at least once laterally to form two annular sectional segments.

19. A method for manufacturing a cradle attachment for gripping a pipe using a forklift comprising:
providing a pipe section having a radius generally the same as the pipe to be gripped;
cutting the pipe section at least once laterally to form two annular sectional segments;
coupling each annular sectional segment to a fork of the forklift such that the convex inner surface of each annular sectional segments faces the inner surface of the other annular sectional segment.

20. The method of claim 19, further comprising:
coupling each annular sectional segment to a corresponding sleeve segment, the sleeve segments configured to couple to the forks of the forklift.
